(19) United States
(12) Patent Application Publication
(10) Pub. No.: US 2026/0072560 A1
(43) Pub. Date: Mar. 12, 2026

(54) METHOD AND SYSTEM FOR QUESTION AND ANSWER BASED ON GENERATIVE AI

(71) Applicant: SAMSUNG SDS CO., LTD., Seoul (KR)

(72) Inventors: In Hye JUNG, Seoul (KR); Yun Kyung Kim, Seoul (KR); Moon Young Kwon, Seouil (KR); Evelyn Min Kyung Lee, Seoul (KR); Jung A Lee, Seoul (KR); Ji Hye Lee, Seoul (KR)

(73) Assignee: SAMSUNG SDS CO., LTD., Seoul (KR)

(21) Appl. No.: 19/295,075

(22) Filed: Aug. 8, 2025

(30) Foreign Application Priority Data
Sep. 10, 2024 (KR) 10-2024-0122749
Oct. 30, 2024 (KR) 10-2024-0150886

(51) Int. Cl. G06F 3/04812; G06F 3/0482; G06F 16/3329

(52) U.S. Cl. CPC G06F 3/04812; G06F 3/0482; G06F 16/33295

(57) ABSTRACT

A question-answering method may comprise determining a focus object in response to a predefined response-requesting shortcut input, displaying a prompt input window adjacent to the focus object, and displaying a response display window at an input position of the prompt input window for a query input into the prompt input window, wherein a response displayed in the response display window is a response generated by a generative artificial intelligence (AI) service using the focus object and the query.

### CROSS-REFERENCE TO RELATED APPLICATION(S)

This application claims priority from Korean Patent Application No. 10-2024-0122749 filed on Sep. 10, 2024, and Korean Patent Application No. 10-2024-0150886 filed on Oct. 30, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for generating a response to a user query by using a generative artificial intelligence (AI) service, and more specifically, to a method and system for generating an optimized response to a user query by using a generative AI service and displaying the response on a computing device.

### 2. Description of the Related Art

A question-answering service based on artificial intelligence (AI) technology is provided. For example, generative AI, which is a technology that generates new content based on input data, can generate desired responses to user queries when combined with natural language processing (NLP) technology.

However, conventional question-answering services based on generative AI services often generate responses based on simple keyword matching, which frequently results in responses that are not highly relevant to the query. As such, they fail to understand the context of the question and merely provide results that contain similar keywords, which reduces the accuracy of the information. Additionally, users must manually input target information and work context when asking a question, and often have to ask multiple questions or input lengthy filenames to obtain the desired answer, which is cumbersome.

Furthermore, in order to use a generative AI service during a task, users have to leave the application or browser they are working in and move to a separate area, which is inconvenient. Consequently, users must close related services or documents and move to the AI service to input filenames and specific context as text, which causes inconvenience. Moreover, when a desired response is not obtained, users must return to the prompt, revise the command, or have difficulty understanding the details of the response.

Accordingly, there is a need for a service that provides contextually appropriate responses to user queries while enabling query input and response display without leaving the work environment, so that users can maintain the workflow during the task.

### SUMMARY

One objective of the present disclosure is to provide a method and system that determine an object targeted by a user query based on a user's input to a computing device and provide a continuous conversation related to the determined object using a generative Artificial Intelligence (AI) service.

Another objective of the present disclosure is to provide a method and system that generate and provide a response corresponding to the context of a user query by using a generative AI service with reference to service usage information stored on a user's computing device.

Yet another objective of the present disclosure is to provide a method and system that enable an immediate response to an additional user query regarding a previously generated answer to a user query using generative AI, without needing to move to a separate prompt.

The objectives of the present disclosure are not limited to those mentioned above, and other objectives not explicitly stated will be clearly understood by those skilled in the art based on the following description.

According to an aspect of the present disclosure, there is provided a question-answering method performed by a computing device. The question-answering method may comprise determining a focus object in response to a predefined response-requesting shortcut input, displaying a prompt input window adjacent to the focus object, and displaying a response display window at an input position of the prompt input window for a query input into the prompt input window, wherein a response displayed in the response display window is a response generated by a generative artificial intelligence (AI) service using the focus object and the query.

In some embodiments, the determining of the focus object comprises determining, as the focus object, an object selected at a time of the predefined response-requesting shortcut input.

In some embodiments, the focus object comprises a plurality of objects, and the selected object is displayed in a selected state in response to a predefined highlighting shortcut input.

In some embodiments, the determining of the focus object comprises determining, as the focus object, an object adjacent to a cursor position at a time of the predefined response-requesting shortcut input.

In some embodiments, the determining of the focus object comprises determining the focus object using behavior of a user of the computing device, and the behavior of the user is a sequence of user inputs entered into the computing device.

In some embodiments, wherein the determining of the focus object using the behavior of the user of the computing device comprises, when a command execution history exists in a popup menu displayed after a first object is selected, determining the first object as the focus object.

In some embodiments, the displaying of the prompt input window comprises displaying the focus object in a first manner to be visually distinguishable from adjacent objects when displaying the prompt input window.

In some embodiments, the displaying of the focus object in the first manner comprises changing a display mode of the focus object from a second manner, which indicates a focused state, to the first manner, and the second manner is visually different from the first manner.

In some embodiments, the response displayed in the response display window is a response generated by the generative AI service using the focus object, the query, and service usage information of a user of the computing device, and the service usage information is user-related information retrieved from a database using the query.

In some embodiments, when the query includes a predefined pronoun phrase, the response displayed in the response display window is a response generated using a query in which the focus object and the predefined pronoun phrase are replaced with information on the focus object.

In some embodiments, the displaying of the prompt input window comprises displaying, adjacent to the prompt input window, a window displaying recommended query content determined using behavior of a user of the computing device.

In some embodiments, the displaying of the window displaying the recommended query content adjacent to the prompt input window comprises: performing at least one of selection and input of a first keyword in a plurality of different applications; and determining recommended query content related to the first keyword when a total number of executions exceeds a reference value.

In some embodiments, the displaying of the response display window at the input position of the prompt input window comprises, when a first additional query input into the prompt input window is regarding response content displayed in the response display window, displaying a response to the first additional query through a first additional response display window displayed adjacent to the response display window together with the response display window.

In some embodiments, the response to the first additional query is a response generated by the generative AI service using the response content displayed in the response display window and the first additional query.

In some embodiments, the displaying of the response to the first additional query comprises, when a second additional query input into the prompt input window is regarding response content displayed in the first additional response display window, displaying a response to the second additional query through a second additional response display window displayed adjacent to the first additional response display window together with the response display window and the first additional response display window.

According to another aspect of the present disclosure, there is provided a computing device. The computing device may comprise a communication interface configured to receive a predefined response-requesting shortcut input, a memory configured to load a computer program, and at least one processor configured to execute the computer program, wherein the computer program includes: instructions to determine a focus object in response to the predefined response-requesting shortcut input; instructions to display a prompt input window adjacent to the focus object; and instructions to display a response display window at an input position of the prompt input window for a query input into the prompt input window, and a response displayed in the response display window is a response generated by a generative artificial intelligence (AI) service using the focus object and the query.

In some embodiments, the instructions to determine the focus object include instructions to determine, as the focus object, an object selected at a time of the predefined response-requesting shortcut input.

In some embodiments, the focus object comprises a plurality of objects, and the selected object is displayed in a selected state in response to a predefined highlighting shortcut input.

In some embodiments, the instructions to determine the focus object include instructions to determine, as the focus object, an object adjacent to a cursor position at the time of the predefined response-requesting shortcut input.

According to still another aspect of the present disclosure, there is provided a question-answering system. The question-answering system may comprise a question-answer display system, and a generative artificial intelligence (AI) service, wherein the question-answer display system includes: instructions to determine a focus object in response to a predefined response-requesting shortcut input; instructions to display a prompt input window adjacent to the focus object, and instructions to display a response display window at an input position of the prompt input window for a query input into the prompt input window, a response displayed in the response display window is a response generated by the generative AI service using the focus object and the query.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram of a question-answering system according to an embodiment of the present disclosure;

FIG. 2 is a flowchart illustrating a question-answering method according to an embodiment of the present disclosure;

FIG. 3 is a diagram illustrating an example in which a focus object is displayed in a first manner to be visually distinguishable from adjacent objects in some embodiments of the present disclosure;

FIG. 4 is a diagram illustrating an example in which a response to a user query is generated using a generative AI service with reference to user usage information in some embodiments of the present disclosure;

FIG. 5 is a diagram illustrating an example of a response displayed in a response display window when a predefined pronoun phrase is included in a user query, in some embodiments of the present disclosure;

FIG. 6 is a diagram illustrating an example in which a window displaying recommended query content is displayed adjacent to a prompt input window in some embodiments of the present disclosure;

FIGS. 7A through 7D are diagrams illustrating an example in which a first additional query regarding response content and a response to the first additional query are displayed adjacent to the response display window in some embodiments of the present disclosure;

FIGS. 8A and 8B are diagrams illustrating an example in which a second additional query regarding the response content to the first additional query and a response to the second additional query are displayed adjacent to the response display window of the first additional query in some embodiments of the present disclosure;

FIG. 9 is a diagram illustrating an example in which a prompt input window is displayed adjacent to a determined focus object in some embodiments of the present disclosure;

FIG. 10 is a diagram illustrating an example in which an object selected at the time of a response-requesting shortcut input is determined as a focus object in some embodiments of the present disclosure;

FIG. 11 is a diagram illustrating an example in which multiple focus objects are selected in some embodiments of the present disclosure;

FIG. 12 is a diagram illustrating an example in which an object with a command execution history in a popup menu is determined as a focus object in some embodiments of the present disclosure;

FIG. 13 is a diagram illustrating an example in which the display mode of a focus object is changed from a second manner to the first manner in some embodiments of the present disclosure; and

FIG. 14 is a block diagram of the hardware components of a computing system described in some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

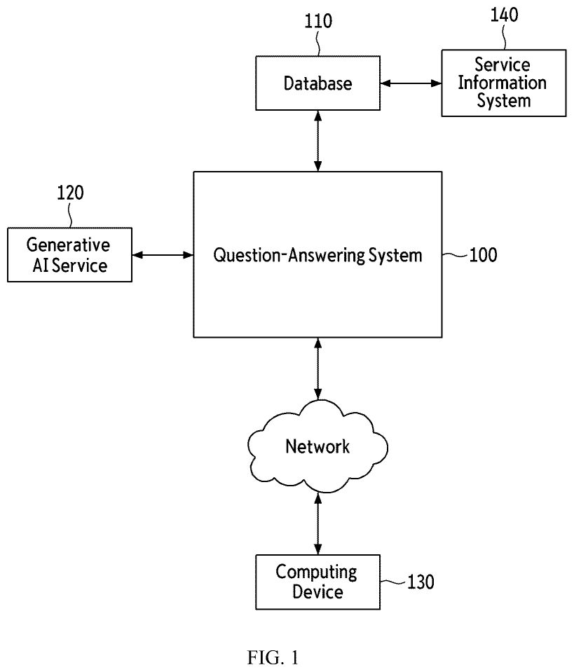

FIG. 1 is a block diagram of a question-answering system according to an embodiment of the present disclosure. As shown in FIG. 1, a question-answering system 100 may operate in conjunction with a database 110, a generative artificial intelligence (AI) service 120, a computing device 130, and a service information system 140. The operation of the question-answering system 100 will hereinafter be described in detail.

The question-answering system 100 may receive a predefined response-requesting shortcut input from the computing device 130. The response-requesting shortcut input may include a shortcut key or a floating button. The response-requesting shortcut may be a form of input that allows a user to invoke the generative AI service 120 directly from a work environment without moving to a separate generative AI search window to write a query when needed while using a service application.

The question-answering system 100 may be understood in greater detail with reference to other embodiments to be described later. In addition, the technical idea that can be understood through this embodiment may also be reflected in other embodiments to be described later, even if not explicitly stated.

The question-answering system 100 may determine a focus object in response to the response-requesting shortcut input. The focus object may include an object that is the target of a response to a query using the generative AI service 120. A prompt input window may be displayed adjacent to the focus object, and a response display window for a query input into the prompt input window may be displayed at the input position of the prompt input window. That is, by positioning the prompt input window and the response display window adjacent to the focus object, the user may immediately receive a response to the query using the generative AI service 120 without moving to a separate prompt while performing a task, thereby maintaining the workflow. Here, the term “adjacent” may refer to a position within a predetermined distance from a comparison target.

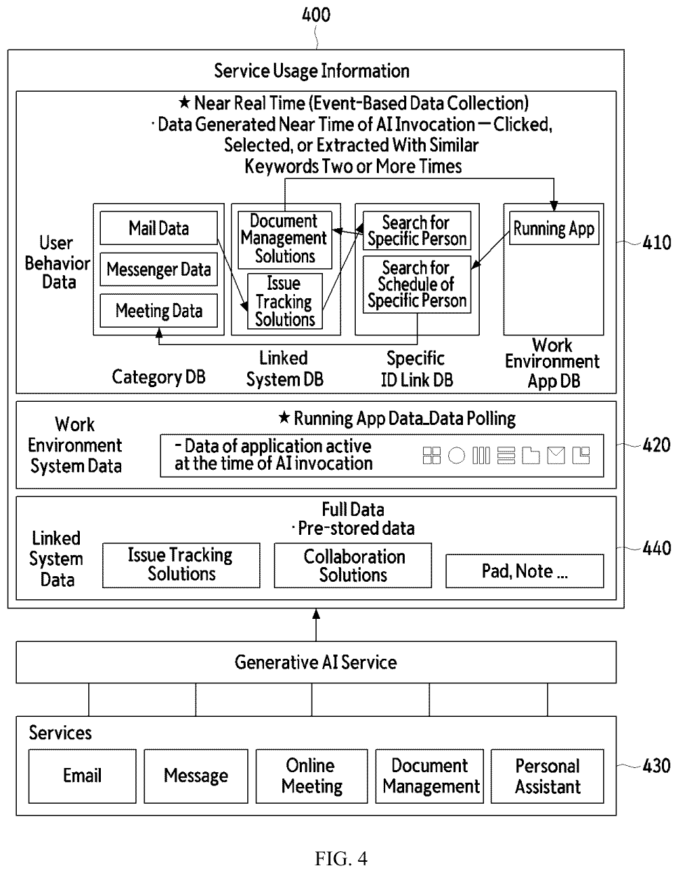

The question-answering system 100 may include the database 110, which is a storage device in which a focus object, a query, and service usage information of the user of the computing device 130 are stored in order to generate a response displayed in the response display window using the generative AI service 120. The service information system 140 collects the focus object, query, and service usage information of the user of the computing device 130 through the computing device 130 and stores the collected information in the database 110. An example in which a response displayed in the response display window is generated by the generative AI service 120 using the service usage information retrieved from the database 110 will hereinafter be described in detail with reference to FIG. 4.

FIG. 4 is a diagram illustrating an example in which a response to a user query is generated using a generative AI service with reference to usage information of the user in some embodiments of the present disclosure. Referring to FIG. 4, service usage information 400 of the user may include user behavior data 410, work environment system data 420, and service data 430. The user behavior data 410 may include data such as two or more clicks, selections, and extracted data that occurred shortly before the determination of a focus object as similar keywords. The work environment system data 420 may include data of an application that is active at the time of a query regarding the determined focus object.

The service data 430 may include various services accessible by the generative AI service 120, such as data stored in mail, messenger, meetings, drive storage, and personal data storage. Examples of how some embodiments of the present disclosure are applied to specific service applications will hereinafter be described.

In connection with a mail application, when emails exchanged more than twice are received via forwarding, if the user invokes the generative AI service 120 by entering a shortcut at a point of curiosity in the content discussed in the exchanged emails or in the content of the attached documents, a contextually appropriate response may be generated by referencing collected contextual email, sender information, recipient-specific ID information, email subject, email content, attached files, and email history up to that point.

In connection with a messenger application, when a thread of comments related to image data becomes lengthy in a channel, and the user invokes the generative AI service 120 in the area where a question arises, an augmented prompt may be generated based on contextual information such as workspace, relevant persons included in the channel, and document files created by the relevant persons, allowing a contextually appropriate response to be generated.

In connection with a drive application, when the user desires to know the difference between two similar PPT files, and invokes the generative AI service 120 by dragging the PPT files and entering a query, a contextually appropriate response may be generated based on information of the drive application, the PPT files, the structure of the folder that contains the PPT files, and collected contextual information.

The generative AI service 120 may receive an AI prompt in the form of an intent chat, in which the user enters a query conversationally as if talking to a friend, directly at the point where a response to a query is needed without switching services or screens. Linked system data 440 may include previously stored data used in conjunction with other applications such as Jira, Pad, and Note.

Accordingly, since data is stored in the database 110 after installing a separate application, the user may collect data generated in real time, and extract data from an active application or a previously installed application to generate a response to their query using the generative AI service 120.

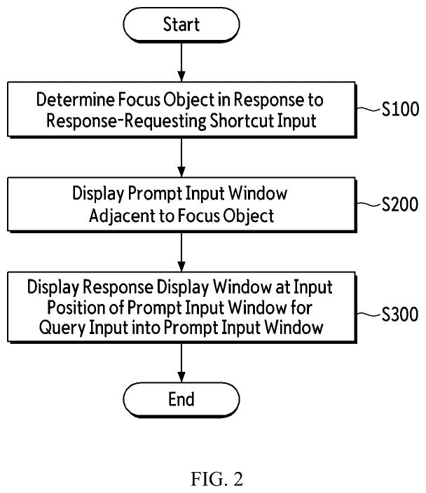

FIG. 2 is a flowchart illustrating a question-answering method according to an embodiment of the present disclosure. The question-answering method according to this embodiment may be performed by one or more computing systems. Also, in the question-answering method according to this embodiment, some steps may be performed by a first computing device, and the remaining steps may be performed by a second computing device. For example, some steps of the question-answering method according to this embodiment may be performed by a service server, and the remaining steps may be performed by a user terminal.

When the subject entity performing each step is omitted, it is to be understood that the subject entity is the question-answering system 100 described with reference to FIG. 1. In addition, it is to be noted that the description of the question-answering system 100 may naturally be applied to the question-answering method according to this embodiment, even if not explicitly mentioned.

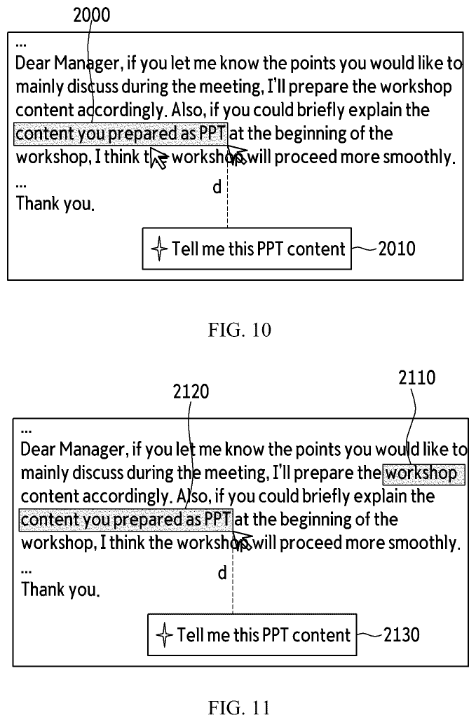

Referring to FIG. 2, in step S100, a focus object may be determined in response to a predefined response-requesting shortcut input. Step S100 may include determining, as the focus object, an object selected at the time of the response-requesting shortcut input. For example, an object dragged by a user of a computing device may be determined as the focus object. In some embodiments, as illustrated in FIG. 10, an object 2000 dragged at the time of the response-requesting shortcut input may be determined as the focus object, and a prompt input window 2010 may be displayed adjacent to the dragged object 2000.

In addition, one or more focus objects may be determined, and the selected object may be displayed in a selected state in response to a predefined highlighting shortcut input. For example, the predefined highlighting shortcut input, which is a user operation for querying a generative AI service, rather than for general dragging, may involve dragging while holding down the “Ctrl” key on the keyboard. Referring to FIG. 11, if the user drags a “content you prepared as PPT” object 2120 with the predefined highlighting shortcut input, after dragging a “at the beginning of the workshop” object 2110, multiple focus objects may be determined. A prompt input window 2130 may be displayed adjacent to the last selected focus object among the multiple focus objects.

Step S100 may include determining, as the focus object, an object adjacent to the cursor position at the time of the response-requesting shortcut input. The object adjacent to the cursor position may refer to any object located within a predefined distance from the cursor position. For example, an adjacent object within a distance of 1 pixel from the cursor position at the time of the response-requesting shortcut input may be determined as the focus object.

Step S100 may include determining the focus object by using the behavior of the user of the computing device. The behavior of the user may be a sequence of user inputs entered into the computing device. The sequence of user inputs entered into the computing device may include user clicks, selections, and extraction actions. By determining the focus object based on the user's behavior on the computing device, a focus object that reflects the user's interest may be selected, and a query related to the focus object reflecting the user's interest may be a query that the user is likely to make through the computing device. Accordingly, the user may be guided to make queries to obtain necessary answers, and responses with high accuracy can be generated.

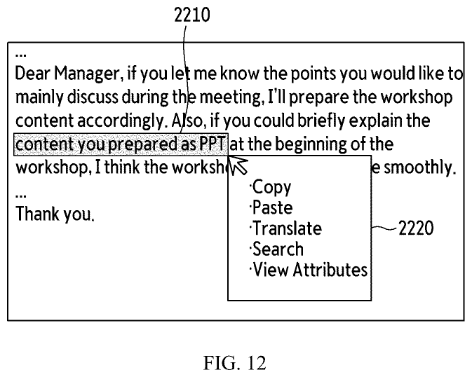

The step of determining the focus object based on the behavior of the user of the computing device may include determining a first object as the focus object when a command execution history exists in a popup menu displayed after the first object is selected. The selection may include a user click input on the first object. The command execution history in the displayed popup menu may include a history of the user's requests to execute commands such as copy, paste, translate, search, and view attributes that are displayed in the popup menu upon selection of the first object. An example of the command execution history in the popup menu displayed after the selection of the first object will hereinafter be described with reference to FIG. 12. Referring to FIG. 12, when the user performs a click input on a first object 2210, a popup menu 2220 may be displayed. If execution of a command on the popup menu 2220 is requested by the user, the first object 2210 with a history of command executions on the popup menu 2220 may be determined as the focus object.

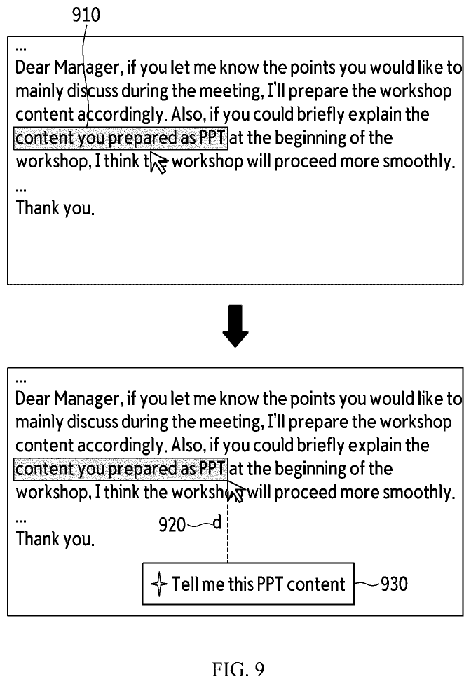

In step S200, a prompt input window may be displayed adjacent to the determined focus object. An example in which the prompt input window is displayed adjacent to the determined focus object will hereinafter be described with reference to FIG. 9. Referring to FIG. 9, when a focus object 910 is determined, a prompt input window 930 may be displayed adjacent to the focus object 910. Specifically, the prompt input window 930 may be displayed within a predefined distance 920 of “d” from the focus object 910. For example, the prompt input window 930 may be located at a distance 920 of 100 pixels from the focus object 910 containing the phrase “content you prepared as PPT.”

Step S200 may include displaying the focus object in a first manner to be visually distinguishable from adjacent objects when displaying the prompt input window. Here, the adjacent objects may refer to text before or after the focus object. The displaying of the focus object in the first manner may include changing the display mode of the focus object from a second manner, which indicates the focused state of the focus object, to the first manner. The second manner may be visually different from the first manner.

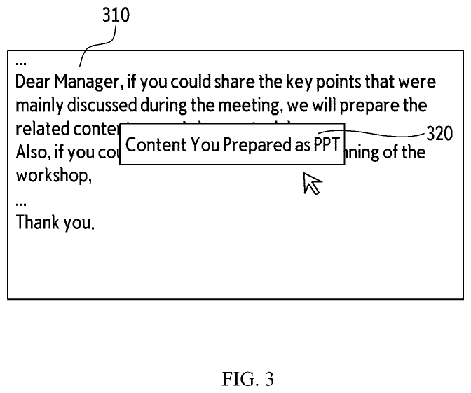

The displaying of the focus object in the first manner will hereinafter be described with reference to FIG. 3. FIG. 3 is a diagram illustrating an example in which a focus object is displayed in the first manner to be visually distinguishable from adjacent objects in some embodiments of the present disclosure. Referring to FIG. 3, according to the first manner, a focus object 320 may be displayed at its position in the form of a floating button including enlarged or bold text, to be distinguishable from adjacent objects 310.

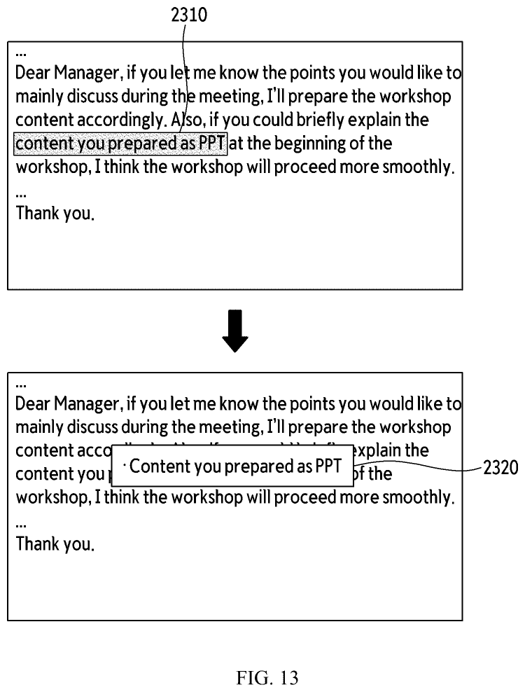

An example of the step of changing the focus object from the second manner to the first manner will hereinafter be described with reference to FIG. 13. In some embodiments, the display mode of the focus object may be changed from the second manner, which is visually different from the first manner to display the focus status of an object, to the first manner. The second manner may include highlighting the focus object. That is, referring to FIG. 13, a focus object 2310 highlighted according to the second manner may be changed to the first manner and displayed at its position in the form of a floating button 2320 including enlarged or bold text. For example, the display mode of the highlighted focus object 2310, which includes the phrase “content you prepared as PPT,” may be changed by enlarging or bolding the phrase “content you prepared as PPT” at the same position and may then be displayed in the form of the floating button 2320. By visually distinguishing the focus object from adjacent objects, each object that may be the target of the user's query may be emphasized, thereby guiding the user to make a query regarding the corresponding object.

Referring back to FIG. 2, in step S300, a response display window for the query input into the prompt input window may be displayed at the input position of the prompt input window. The response displayed in the response display window may be generated by the generative AI service using the focus object and the query. According to the question-answering method of this embodiment, since the user can use the generative AI service immediately at the position where the query is desired during the task, instead of using a separate area for writing a prompt, the workflow can be maintained, and the accuracy of the desired response can be improved. In addition, without moving to a separate generative AI service search window to enter a query, the user can invoke the generative AI service immediately at each necessary position and enter a query, thus avoiding unnecessary processes such as writing a long command in the prompt.

Step S300 may include displaying, adjacent to the prompt input window, a window displaying recommended query content determined using the user's behavior on the computing device. The user's behavior may include click data related to specific keywords or people that the user has interacted with while using various applications. An example in which the window displaying recommended query content determined using the user's behavior on the computing device is displayed adjacent to the prompt input window will hereinafter be described with reference to FIG. 6.

FIG. 6 is a diagram illustrating an example in which a window displaying recommended query content is displayed adjacent to the prompt input window in some embodiments of the present disclosure. Referring to FIG. 6, with respect to a focus object 610, a window 620 displaying recommended query content may be displayed adjacent to the prompt input window by referencing data generated immediately prior to the user's invocation of the generative AI service, application data and movement paths prior to the invocation, and keyword click data. The window 620 displaying recommended query content may include queries that the user is expected to make regarding the focus object 610 and responses to those expected queries.

The step of displaying the window displaying recommended query content adjacent to the prompt input window may include performing at least one of selection and input of a first keyword in a plurality of different applications, and determining the recommended query content related to the first keyword if the total number of executions exceeds a reference value. The selection and input of the first keyword may include click data on specific keywords or people referenced by the user while using various applications.

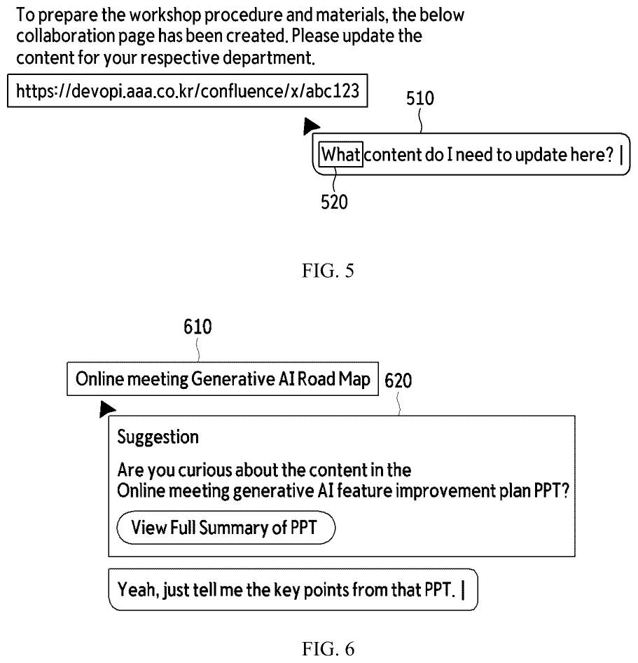

FIG. 5 is a diagram illustrating an example of a response displayed in the response display window when a predefined pronoun phrase is included in the user's query in some embodiments of the present disclosure. Referring to FIG. 5, in the question-answering method according to an embodiment of the present disclosure, when a predefined pronoun phrase 520 is included in a query 510, the response displayed in the response display window may be a response generated using a query in which the focus object and the pronoun phrase 520 are replaced with information on the focus object. For example, when the query 510 includes the predefined pronoun phrase 520, “here,” the response displayed in the response display window may be a response to a query in which the pronoun phrase 520 is replaced with information on the focus object corresponding to “here.” That is, in order to generate a response to the query 510 through the understanding of the context, the information on the focus object corresponding to the pronoun phrase 520 may be included in the query 510. In some embodiments, when the focus object corresponding to the predefined pronoun phrase 520 in the query 510 cannot be identified or when there are multiple focus objects, the user may be requested to confirm the focus object corresponding to the predefined pronoun phrase 520. Accordingly, the user does not need to rewrite the query 510, which may save time, and even if the user does not know specific information regarding the focus object corresponding to the pronoun phrase 520, a response to the query 510 regarding the focus object may still be obtained.

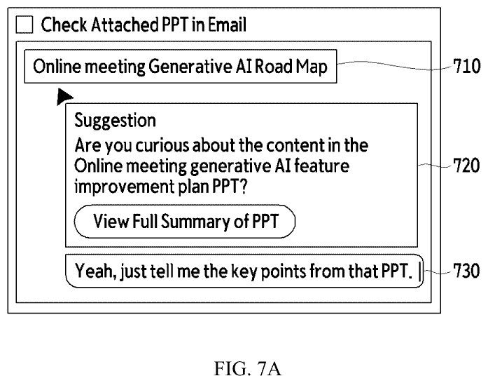

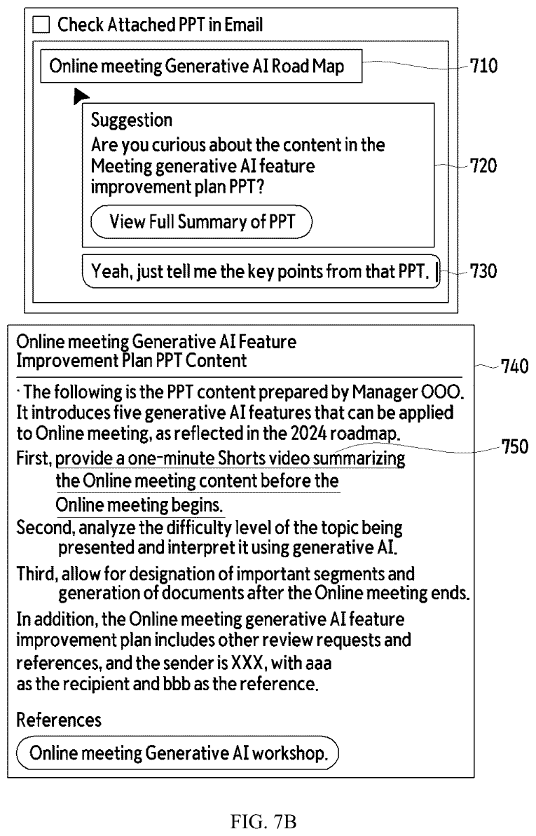

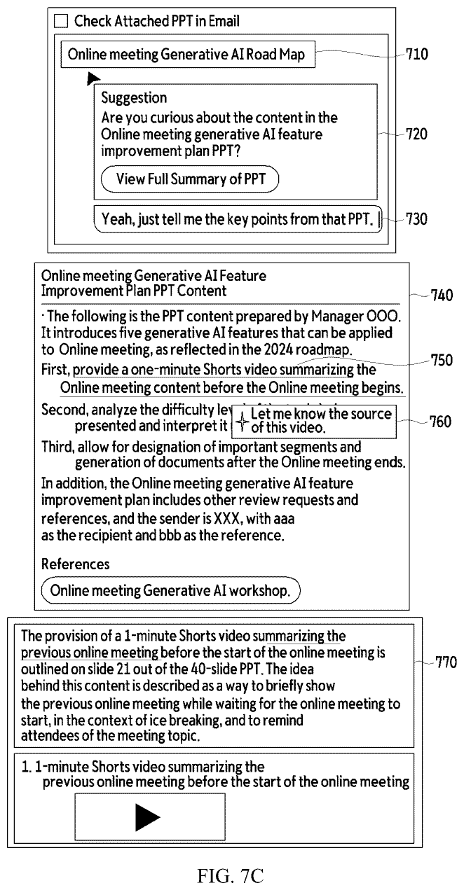

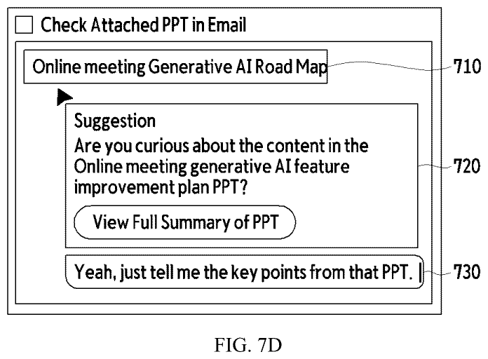

Referring to FIGS. 7A through 7D, in some embodiments, a first additional query regarding response content and a response to the first additional query may be displayed adjacent to the response display window. Specifically, referring to FIG. 7A, a window 720 displaying recommended query content determined using the user's behavior on the computing device may be displayed adjacent to a prompt input window 730 with respect to a focus object 710. Here, the window 720 may be displayed within a predefined distance from the prompt input window 730.

Referring to FIG. 7B, a response display window 740 including response content 750 corresponding to the query input into the prompt input window 730 may be displayed at the input position of the prompt input window 730. The input position of the prompt input window 730 may include the entire area in which the application that has invoked the prompt is active.

Referring to FIG. 7C, when a first additional query 760 input into the prompt input window 730 is regarding the response content 750 displayed in the response display window 740, a first additional response display window 770 may be displayed adjacent to the response display window 740, and a response to the first additional query 760 may be displayed through the first additional response display window 770.

Referring to FIG. 7D, in some embodiments, when the first additional response display window 770 is closed, the response display window 740 may return to its previous state of being displayed at the input position of the prompt input window 730, and when the response display window 740 is also closed, the window 720 may return to the state in which it is displayed adjacent to the prompt input window 730. In some embodiments, the response to the first additional query 760 may be generated by the generative AI service using the response content 750 displayed in the response display window 740 and the first additional query 760.

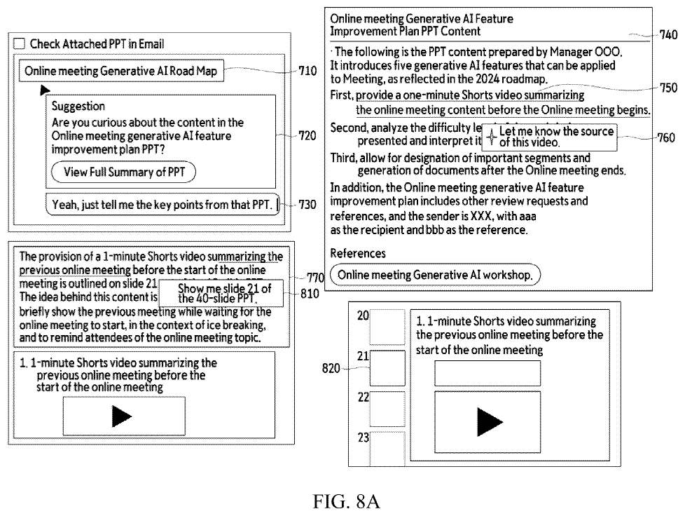

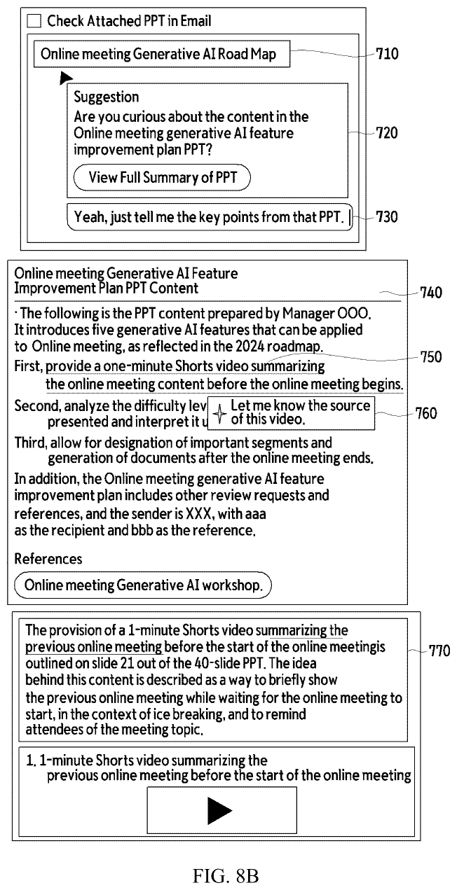

Referring to FIGS. 8A and 8B, in some embodiments, a second additional query 810 regarding the response content displayed in the first additional response display window 770 for the first additional query 760 and a response to the second additional query 810 may be displayed adjacent to the response display window 740 for the first additional query 760. Referring to FIG. 8A, when the second additional query 810 input into the prompt input window 730 is regarding the response content displayed in the first additional response display window 770, a second additional response display window 820 may be displayed adjacent to the first additional response display window 770 together with the response display window 740, and a response to the second additional query 810 may be displayed through the second additional response display window 820. Referring to FIG. 8B, in some embodiments, when the second additional response display window 820 is closed, the first additional response display window 770 may return to its previous state of being displayed adjacent to the response display window 740.

For example, when the second additional query 810 input into the prompt input window 730 is regarding page 21 of a PPT including video content, which is information displayed in the first additional response display window 770, a response 830 to the second additional query 820, including information on page 21 of the PPT may be displayed through the second additional response display window 820, displayed adjacent to the first additional response display window 770 together with the response display window 740 and the first additional response display window 770. Accordingly, by generating a response to the first additional query 760 using the response content, displayed in the response display window 740, and the first additional query 760 through the generative AI service, the user may continue the conversation without interrupting the flow of the conversation, thereby providing a response optimized for the user.

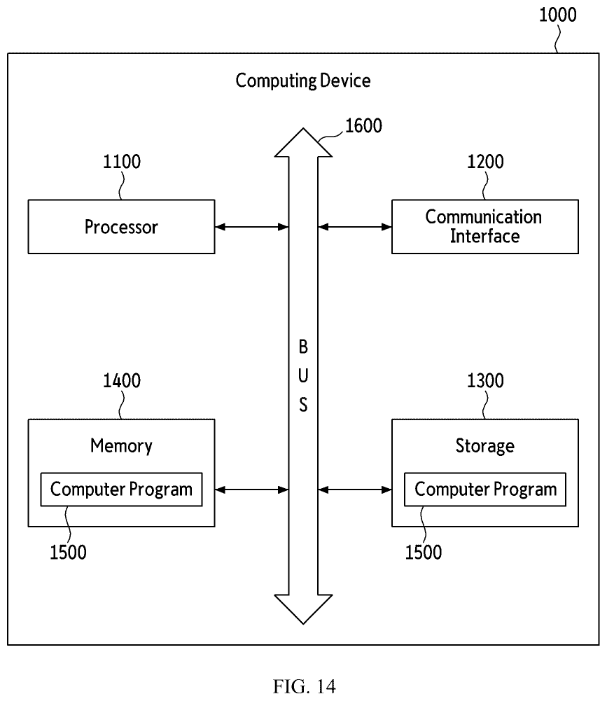

FIG. 14 is a block diagram illustrating a computing system referenced in some embodiments of the present disclosure.

Referring to FIG. 14, a computing system 1000 may include at least one processor 1100, a bus 1600, a communication interface 1200, a memory 1400 that loads a computer program 1500 to be executed by the processor 1100, and a storage 1300 that stores the computer program 1500. It is to be noted that only components relevant to embodiments of the present disclosure are illustrated in FIG. 14. Therefore, one skilled in the relevant art will understand that other general-purpose components, in addition to those illustrated, may also be included. That is, the computing system 1000 may include various additional components besides those depicted in FIG. 14. Furthermore, the computing system 1000 may be implemented with some of the components in FIG. 14 omitted. The components of the computing system 1000 will hereinafter be described. It is also to be noted that, throughout the present disclosure, the terms “computing system 1000” and “computing system” may be used interchangeably.

The processor 1100 may control the overall operations of the components of the computing system 1000. The processor 1100 may include at least one of a central processing unit (CPU), microprocessor unit (MPU), microcontroller unit (MCU), graphics processing unit (GPU), or any type of processor well known in the relevant technical field. The processor 1100 may also perform computation on at least one application or program for executing operations/methods according to embodiments of the present disclosure. The computing system 1000 may include one or more processors.

The memory 1400 may store various data, commands, and/or information. The memory 1400 may load the computer program 1500 from the storage 1300 in order to execute the operations/methods according to embodiments of the present disclosure. The memory 1400 may be implemented as a volatile memory such as random-access memory (RAM), but the present disclosure is not limited thereto.

The bus 1600 may provide a communication function among the components of the computing system 1000. The bus 1600 may be implemented in various forms such as an address bus, data bus, or control bus.

The communication interface 1200 may support wired or wireless internet communication of the computing system 1000. Additionally, the communication interface 1200 may support various other communication methods than internet communication. To this end, the communication interface 1200 may include communication modules well known in the relevant technical field.

The storage 1300 may non-temporarily store one or more computer programs 1500. The storage 1300 may be implemented with non-volatile memory such as read-only memory (ROM), erasable programmable ROM (EPROM), electrically erasable programmable ROM (EEPROM), or flash memory, a hard disk, a removable disk, or any form of computer-readable recording medium well known in the relevant technical field.

The computer program 1500 may include one or more instructions that cause the processor 1100 to perform operations/methods according to various embodiments of the present disclosure when loaded into the memory 1400. That is, the processor 1100 may perform the operations/methods according to various embodiments of the present disclosure by executing the one or more loaded instructions.

For example, the computing system 1000 of FIG. 14 may correspond to the computing device 130 included in the question-answering system 100 described with reference to FIG. 1. In this case, the computing system 1000 may be configured using one or more physical servers included in a server farm based on cloud technology such as a virtual machine. In this case, at least some of the components depicted in FIG. 14, such as the processor 1100, the memory 1400, and the storage 1300, may be virtual hardware, and the communication interface 1200 may also be implemented with virtualized networking elements such as a virtual switch. So far, various embodiments of the present disclosure and their effects have been described with reference to FIGS. 1 through 14. However, the technical effects of the present disclosure are not limited to those set forth herein, and other effects not explicitly mentioned may be clearly understood by one skilled in the relevant art based on the following description.

The computer program 1500 may include: instructions to determine a focus object in response to a response-requesting shortcut input; instructions to display a prompt input window adjacent to the determined focus object; and instructions to display a response display window at the input position of the prompt input window for a query input into the prompt input window, wherein the response displayed in the response display window is a response generated by the generative AI service using the focus object and the query.

So far, a variety of embodiments of the present disclosure and the effects according to embodiments thereof have been mentioned with reference to FIGS. 1 to 14. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A question-answering method performed by a computing device, comprising:
determining a focus object in response to a predefined response-requesting shortcut input;
displaying a prompt input window adjacent to the focus object; and
displaying a response display window at an input position of the prompt input window for a query input into the prompt input window,
wherein a response displayed in the response display window is a response generated by a generative artificial intelligence (AI) service using the focus object and the query.

2. The question-answering method of claim 1, wherein the determining of the focus object comprises determining, as the focus object, an object selected at a time of the predefined response-requesting shortcut input.

3. The question-answering method of claim 2, wherein
the focus object comprises a plurality of objects, and
the selected object is displayed in a selected state in response to a predefined highlighting shortcut input.

4. The question-answering method of claim 1, wherein the determining of the focus object comprises determining, as the focus object, an object adjacent to a cursor position at a time of the predefined response-requesting shortcut input.

5. The question-answering method of claim 1, wherein
the determining of the focus object comprises determining the focus object using behavior of a user of the computing device, and
the behavior of the user is a sequence of user inputs entered into the computing device.

6. The question-answering method of claim 5, wherein the determining of the focus object using the behavior of the user of the computing device comprises, when a command execution history exists in a popup menu displayed after a first object is selected, determining the first object as the focus object.

7. The question-answering method of claim 1, wherein the displaying of the prompt input window comprises displaying the focus object in a first manner to be visually distinguishable from adjacent objects when displaying the prompt input window.

8. The question-answering method of claim 7, wherein
the displaying of the focus object in the first manner comprises changing a display mode of the focus object from a second manner, which indicates a focused state, to the first manner, and
the second manner is visually different from the first manner.

9. The question-answering method of claim 1, wherein
the response displayed in the response display window is a response generated by the generative AI service using the focus object, the query, and service usage information of a user of the computing device, and
the service usage information is user-related information retrieved from a database using the query.

10. The question-answering method of claim 1, wherein, when the query includes a predefined pronoun phrase, the response displayed in the response display window is a response generated using a query in which the focus object and the predefined pronoun phrase are replaced with information on the focus object.

11. The question-answering method of claim 1, wherein the displaying of the prompt input window comprises displaying, adjacent to the prompt input window, a window displaying recommended query content determined using behavior of a user of the computing device.

12. The question-answering method of claim 11, wherein the displaying of the window displaying the recommended query content adjacent to the prompt input window comprises: performing at least one of selection and input of a first keyword in a plurality of different applications; and determining recommended query content related to the first keyword when a total number of executions exceeds a reference value.

13. The question-answering method of claim 1, wherein the displaying of the response display window at the input position of the prompt input window comprises, when a first additional query input into the prompt input window is regarding response content displayed in the response display window, displaying a response to the first additional query through a first additional response display window displayed adjacent to the response display window together with the response display window.

14. The question-answering method of claim 13, wherein the response to the first additional query is a response generated by the generative AI service using the response content displayed in the response display window and the first additional query.

15. The question-answering method of claim 13, wherein the displaying of the response to the first additional query comprises, when a second additional query input into the prompt input window is regarding response content displayed in the first additional response display window, displaying a response to the second additional query through a second additional response display window displayed adjacent to the first additional response display window together with the response display window and the first additional response display window.

16. A computing device comprising:
a communication interface configured to receive a predefined response-requesting shortcut input;
a memory configured to load a computer program; and
at least one processor configured to execute the computer program,
wherein
the computer program includes: instructions to determine a focus object in response to the predefined response-requesting shortcut input; instructions to display a prompt input window adjacent to the focus object; and instructions to display a response display window at an input position of the prompt input window for a query input into the prompt input window, and
a response displayed in the response display window is a response generated by a generative artificial intelligence (AI) service using the focus object and the query.

17. The computing device of claim 16, wherein the instructions to determine the focus object include instructions to determine, as the focus object, an object selected at a time of the predefined response-requesting shortcut input.

18. The computing device of claim 17, wherein
the focus object comprises a plurality of objects, and
the selected object is displayed in a selected state in response to a predefined highlighting shortcut input.

19. The computing device of claim 17, wherein the instructions to determine the focus object include instructions to determine, as the focus object, an object adjacent to a cursor position at the time of the predefined response-requesting shortcut input.

20. A question-answering system comprising:
a question-answer display system; and
a generative artificial intelligence (AI) service,
wherein
the question-answer display system includes: instructions to determine a focus object in response to a predefined response-requesting shortcut input; instructions to display a prompt input window adjacent to the focus object; and instructions to display a response display window at an input position of the prompt input window for a query input into the prompt input window,
a response displayed in the response display window is a response generated by the generative AI service using the focus object and the query.
